(19) United States
(12) Patent Application Publication
(10) Pub. No.: US 2026/0110870 A1
(43) Pub. Date: Apr. 23, 2026

(54) ASYMMETRIC MOUNTING APPARATUS

(71) Applicant: Element Six Technologies Limited, Didcot Oxfordshire (GB)

(72) Inventors: Michael Ian PEARSON, Harwell, Oxfordshire (GB); Teodoro GRAZIOSI, Harwell, Oxfordshire (GB); Francis Mark REININGER, Pasadena, CA (US)

(21) Appl. No.: 19/116,899

(22) PCT Filed: Sep. 27, 2023
(86) PCT No.: PCT/EP2023/076700

§ 371 Date: Mar. 28, 2025

Related U.S. Application Data
(60) Provisional application No. 63/377,816, filed on Sep. 30, 2022.

(30) Foreign Application Priority Data
Oct. 19, 2022 (GB) 2215430.6

(51) Int. Cl. G02B 7/00; G02B 1/02

(52) U.S. Cl. CPC G02B 7/007; G02B 1/02; G02B 7/008

(57) ABSTRACT

A window assembly comprising: a frame defining an opening; a ceramic window; wherein the frame is bonded to the ceramic window to substantially cover the opening; and wherein the frame comprises two portions, wherein the thickness of a first portion of the two portions in the direction perpendicular to the main plane of the opening is smaller than the thickness of a second of the two portions in the direction perpendicular to the plane of the opening.

This invention was made with US Government support under Contract No. FA8651-21-C-0003 awarded by the United States Air Force. The US Government has certain rights in this invention.

### FIELD OF THE INVENTION

The present invention relates to ceramic window assemblies, in particular synthetic diamond windows and mounting configurations for such windows.

### BACKGROUND

Plates of synthetic diamond material are now available in a variety of different grades and for a range of applications. Examples include optical grades of synthetic diamond material for optical applications, thermal grades of synthetic diamond material for thermal management in semiconductor applications, and electrically conductive boron doped diamond grades for electrodes in electrochemical applications. Synthetic diamond materials have a number of advantageous features for such applications including extreme hardness, high optical transparency across a wide frequency range, high thermal conductivity, chemical inertness, and wide potential window.

There remain several problems in utilizing synthetic diamond plates for certain applications. One of the main limitations for applications which require large area plates is that plates of synthetic diamond material are only available up to a certain size. This size limitation is a result of the difficulty in generating and maintaining the extreme conditions required to grow diamond material over a large area. The largest high quality synthetic diamond plates currently available are polycrystalline chemical vapour deposited (CVD) diamond plates which can be fabricated as circular wafers up to around 120 mm in diameter. The circular symmetry of such large area wafers is inherent from the circular symmetry of the microwave plasma activated chemical vapour deposition apparatus used in the synthesis process.

While synthetic diamond plates have extreme hardness and resistance to scratching, the diamond material is brittle and can be prone to fracture if not mounted and handled correctly. Furthermore, the combination of high hardness and low toughness can make diamond material difficult to process into precise geometries without fracturing the material or introducing significant surface and sub-surface damage. Further still, while the chemical inertness of diamond can be an advantage for many applications, it does mean that diamond components can be difficult to bond into mounting configurations using standard adhesives and mounting structures. Further still, while the low thermal expansion coefficient of diamond material can be advantageous, for example to avoid thermal lensing effects, the rigidity of the diamond material in combination with a thermal expansion mismatch to the mounting material can lead to thermally induced stresses and potential de-bonding or fracture of the diamond component.

Ceramic materials, such as diamond, typically have high compressive strength but their tensile strength is comparatively low. These materials are brittle and so their mechanical failure threshold is determined by the largest flaw in a region under tensile stress. The distribution of flaws results in a statistical distribution of threshold stresses, dependent on critical flaw size. When these materials fail under stress, the mechanism is typically brittle fracture, leading to catastrophic failure of a component. Due to a low tensile strength compared to compressive strength, statistical distribution of strengths, and brittle fracture mechanism, it is desirable to design ceramic components so they are primarily in compression, while avoiding tensile forces. If is not possible to avoid tensile forces, large safety margins are required to ensure a component does not fail in use.

Most ceramic materials have a low coefficient of thermal expansion (CTE) compared to metals and/or alloys. When a ceramic window is bonded to a mount comprising a metal, the bonding process is typically carried out at a high temperature. Both parts, the ceramic window and the mount, are typically under low stress during the bonding process, or directly after the bonding while the temperature is still high. However, when subsequently the window and the attached mount cool down, the mount will contract more than the ceramic material, causing significant stress in the mount and the window.

### STATEMENT OF INVENTION

According to a first aspect of the invention, there is provided a window assembly comprising: a frame defining an opening; a ceramic window; wherein the frame is bonded to the ceramic window to substantially cover the opening; and wherein the frame comprises two portions, wherein the thickness of a first portion of the two portions in the direction perpendicular to the main plane of the opening is smaller than the thickness of a second of the two portions in the direction perpendicular to the plane of the opening.

The first may be a U-shaped portion, and the second portion may bridge the legs of the U-shaped portion. The U-shape may include three generally straight parts, whereby each part is connected perpendicularly to the adjacent part. Alternatively, the connection may comprise rounded corners between the adjacent parts, and/or at least some of the parts of the U-shape may be curved. The bridge portion improves the symmetry of the frame and reduces tensile stress. The first and second portions may together form a rectangular frame.

The first portion may have a cross-section in a direction perpendicular to the main plane of the opening, wherein the cross-section has a wedge shape, and wherein the narrow part of the wedge shape is on the side of the opening, and wherein the wide part of the wedge shape is on the side of the perimeter of the frame.

Alternatively, the first portion may have a cross-section in a direction perpendicular to the main plane of the opening, wherein the cross-section is substantially rectangular.

The window assembly may comprise a gradual transition from the thickness of the first portion to the thickness of the second portion.

The perimeter of the opening may comprise an oval, a rectangular shape, or a rectangular shape with rounded corners.

The external perimeter of the frame may comprise an oval, rectangular shape, or a rectangular shape with rounded corners.

The first portion may comprise a coefficient of thermal expansion different from a coefficient of thermal expansion of the second portion.

The frame may molybdenum, and/or the window material may be synthetic diamond. The material of the first portion may comprise a ceramic, synthetic diamond, tungsten, or fused silica material.

The window assembly may be capable of operating at a temperature up to 800° C. without fracturing or without the bond between the window and the frame releasing.

The window assembly may further comprise a detector, arranged within an optical path defined by the frame and the window, wherein the optical path is at a non-zero angle to the normal of the main plane.

The ceramic window optionally has a maximum deflection, measured perpendicular to a main plane of the window of no more than 4.5×10⁻⁵ times a longest linear dimension of the window, and preferably no more than 2.0×10⁻⁵ times the longest linear dimension of the window. It is beneficial to reduce deflection to ensure that lensing of light or other radiation passing through the ceramic window is minimised.

As an option, the ceramic window has a largest linear dimension selected from any of between 10 mm and 130 mm, between 20 mm and 60 mm, and between 25 mm and 50 mm.

The ceramic window optionally has an average thickness selected from any of between 200 μm and 1500 m, between 300 μm and 1000 μm, and between 400 μm and 800 μm. In practice, a thicker ceramic window is less prone to deflection but is more highly stressed, whereas a thinner ceramic window has lower stress but is more prone to deflection.

As a further option, the ceramic window has a peak to valley flatness selected from any of less than 100, less than 80 and less than 40×λ/12 interference fringes over a largest linear length of the ceramic window. Flatness can be measured using a 633 nm light interferometer. Optical interference creates a fringe pattern, and each fringe corresponds to a λ/2 variation in flatness. The number of λ/2 interference fringes is therefore a measure of the flatness of the ceramic window.

As an option, the frame is chemically bonded to the ceramic window to substantially cover the opening.

According to a second aspect of the invention, there is provided a method of manufacturing a window assembly according to any one of the preceding claims, the method comprising: providing the ceramic window; providing the frame; bonding the ceramic window to the frame; wherein the frame comprises two portions, wherein the thickness of a first portion of the two portions in the direction perpendicular to the main plane of the opening is smaller than the thickness of a second of the two portions in the direction perpendicular to the plane of the opening.

The method may further comprise, prior to said step of providing the frame, creating the frame with said first portion comprising a different material from said second portion.

The method optionally further comprises mechanically processing the ceramic window after bonding the ceramic window to the frame.

According to a third aspect of the invention, there is provided an optical device, comprising a ceramic window assembly according to the first aspect.

### FIGURES

Some embodiments of the invention will now be described by way of example only and with reference to the accompanying drawings, in which:

FIGS. 1A and 1B show a cross section and top-view of a schematic window assembly;

FIGS. 2A and 2B show a cross section and top-view of a schematic window assembly;

FIGS. 3A and 3B show a cross section and top-view of a schematic window assembly;

FIGS. 4A and 4B show a side view of two schematic window assemblies;

FIGS. 5A and 5B illustrate two top-views of schematic window assemblies; and

FIG. 6 illustrates stress modelling of a window assembly;

FIG. 7 illustrates stress modelling of a window assembly shown in FIG. 2;

FIG. 8 illustrates stress modelling of a window assembly as show in in FIG. 3; and

FIG. 9 is a flow diagram illustrating a method of manufacturing the window assembly.

### SPECIFIC DESCRIPTION

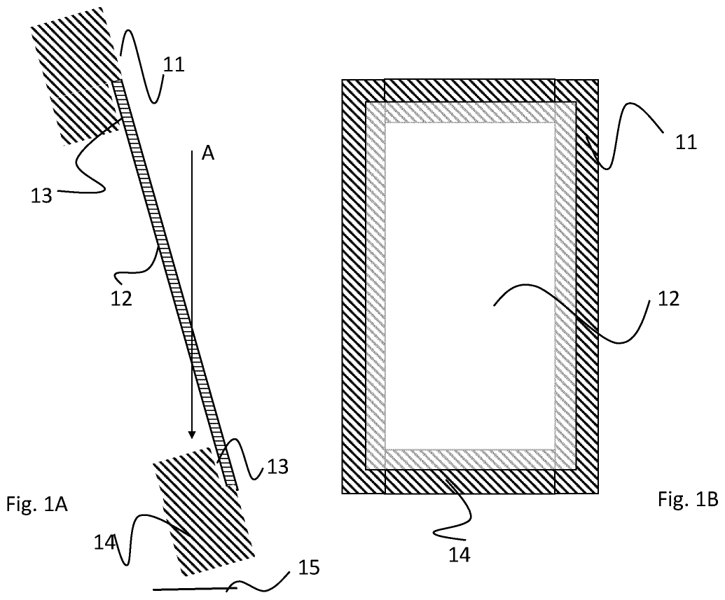

The inventors have realised that optical transmission at a low angle of incidence onto a ceramic window such as a synthetic diamond window can be made possible, while at the same time controlling the distribution of stress across the window. In particular, the distribution of stress can be controlled to mitigate tensile stress on the window. FIGS. 1A and 1B illustrate a window assembly with a frame 11 defining an opening and a ceramic window 12 arranged over the opening. The frame comprises a metal or an alloy (e.g., molybdenum or molybdenum alloy). The frame is chemically bonded to the window. The window assembly is intended to be used at temperatures up to 800° C. A chemical bond 13 between the frame and the window capable of withstanding such operating temperatures is typically created at a temperature higher than 800° C. For example, a gold based braze with an approximate melting temperature of 1100° C. could be used. Another example of a high temperature bond is an Ag-Ti braze. However, lower temperature diffusion bonds are also a possibility. The large variations in temperature during the bonding process and operation cause compressive stress within the window due to the different expansion rates of the ceramic window and the frame.

FIG. 1A also illustrates an optical detector 15, sensitive to light propagating through window 12, but the light does not reach the detector because it is blocked by the frame.

The words ‘frame’ and ‘mount’ are used interchangeably herein. Although the frame can be used for mounting the window assembly, that is not necessarily the purpose of the frame. An alternative use for the frame is that of a cooling channel. In such an arrangement, the frame defines a hollow channel for guiding cooling fluids through the frame, and separate attachments may be provided for mounting the assembly.

Both parts, i.e. the ceramic window and the metallic mount, are typically not under stress during the bonding process, or directly after the bonding while the temperature is still high. However, when the window and the attached metallic mount cool down, the metallic mount contracts more than the ceramic material, causing stress both in the mount and the window. The inventors have realised that if the mount shape is symmetric relative to the plane of the ceramic window, the window is primarily under compressive stress after cooling down, and the risk of fracture of the window is often below a critical failure threshold. The risk of fracture is below the critical failure threshold due to the high compressive strength of ceramic materials relative to that of other materials, or relative to tensile strength of the ceramic materials.

The coefficient of thermal expansion (CTE) of a ceramic is generally lower (although this is not always the case) than a metal. For example, diamond has a CTE of 1.07×10⁻⁶K⁻¹ at 300K (room temperature), whereas molybdenum has a CTE of 4.8×10⁻⁶K⁻¹ at 300K and aluminium has a CTE of 2.4×10⁻⁵K⁻¹ at 300K.

The directionality (i.e., tension, compression, shear etc.) of the residual stress depends on the shape and relative placement of the window with respect to the frame, for example whether the window is mounted in the space completely within the frame defined by the aperture or, as shown in FIG. 1B, against the frame to cover the aperture. The direction further depends on the shape and relative placement of the bond with respect to the window and frame. For example, whether the bond between the window and frame is around the entire peripheral edge of the window, or only along certain sections of the window, the relative placement of those sections etc. The shape of the frame also determines the stress. The magnitude and directionality of the stress and strain in the window 12 and mount 11 can be calculated using commercial software, such as ABAQUS™.

The generally rectangular shape of the frame provides at least symmetries along two axes through the centre of the assembly. The symmetry of the frame ensures a primarily compressive stress in the window, while tensile stress due to deformation of the window in the direction perpendicular to the main frame of the window is lower than it would be if one of the sides of the frame is omitted. The symmetry of the window reduces tensile stress, and primarily causes compressive stress onto the window. However, a drawback of this frame arrangement is that the frame blocks light propagating through the window at a shallow angle. As illustrated in FIG. 1A, light propagating in the direction of arrow A through the window is blocked by the lower part of the frame 14.

As explained, the symmetries of the rectangular frame reduce or avoid tensile stress in the window. It is therefore not preferable to remove the lower part 14 of the frame such that a clear path for light is provided. If the lower part 14 of the window is removed and the remaining frame has an inverted U-shape, there will be increased tensile stresses in the window or deformation of the window in the direction perpendicular to the main plane, compared to the four-sided frame. The window may fracture due to the tensile stresses, or the operating ranges may be limited to avoid fracture.

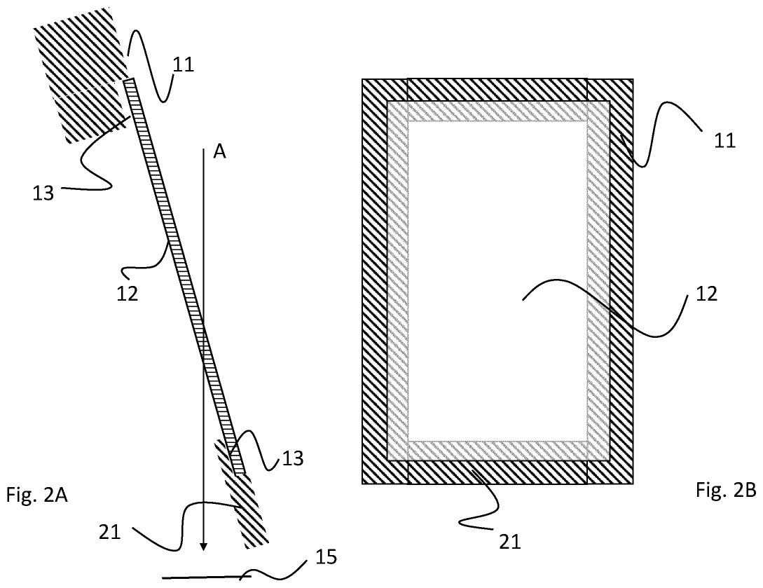

A first example of a window assembly addressing these challenges is illustrated in FIGS. 2A and 2B. Parts of the assembly that are the same as corresponding parts in FIGS. 1A and 1B have been numbered likewise and are not described again. The top view illustrated in FIGS. 1B and 2B appears the same because shape of the frame in the main plane of the window assembly is substantially the same. The cross sections illustrated in FIGS. 1A and 2A are different, though. A decrease of the thickness of a lower portion 21 of the frame in the direction perpendicular to the main plane when compared to the FIG. 1A arrangement provides an unobstructed optical path. At the same time, the four-sided frame avoids or reduces tensile stress due an un-even expansion across the frame. A symmetry along a vertical axis through the centre of the assembly shown in FIG. 2B is returned, even though the symmetry through the horizontal axis through the centre of the assembly shown in FIG. 2B is broken due to the asymmetric thickness of the frame.

Introducing a thin frame portion reduces the maximum tensile stress with little cost to the field of view. Due to the reduced stiffness of this smaller rectangular cross-section compared to the three other bonded sides, there is still an increase of the tensile stress when compared to a full four-sided bonded mount like illustrated in FIGS. 1A and 1B. If the tensile stress is kept below a failure threshold during use such that the window does not fracture, the tensile stress may be acceptable.

As an optional further feature, the material of the lower portion 21 may be different than the material of the rest of the frame to reduce the tensile stress further. The stiffness of the material of the lower portion 21 can be made larger than the stiffness of the material of the rest of the frame to improve the symmetry of the stress distribution. The material of the frame may be molybdenum, and the stiffness of the lower portion may be increased by choosing a different material, or by creating an molybdenum alloy with increased stiffness. A relatively large concentration of other alloy materials is required to significantly change the stiffness.

Materials can be selected to achieve the technical effect of compensating for a thinner structure with a lower CTE. The material of the lower portion 21 could be one of: a ceramic, synthetic diamond, tungsten, or fused silica material. Each of these options could be combined with the mount material being molybdenum.

The material of the top part of the frame may also be chosen to reduce the coefficient of thermal expansion. When the overall coefficient of thermal expansion of the total frame is reduced, the effect of the asymmetry of the frame thickness on the tensile stress is reduced as well.

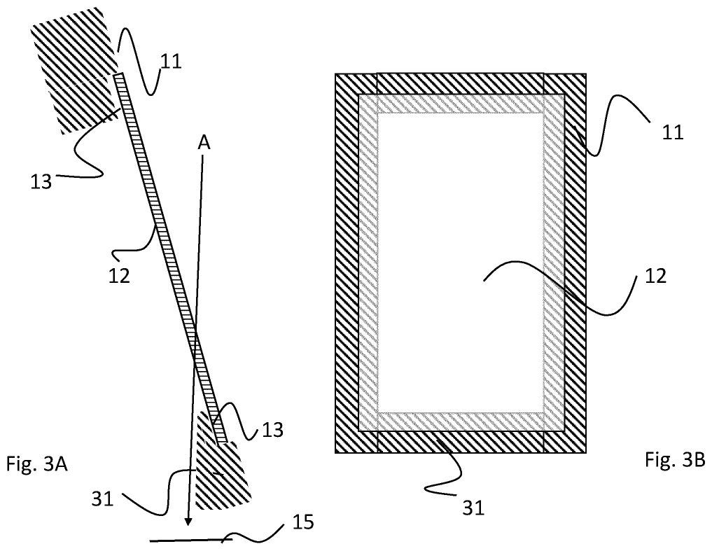

A second example of a window assembly is illustrated in FIGS. 3A and 3B. The maximum tensile stress can be further reduced compared to the embodiment in FIGS. 2A and 2B by replacing the thin frame section 21 with a frame section with a wedge-shaped cross-section 31. The wedge is oriented such that the narrow part of the wedge shape is at the opening whilst the wide part is on the perimeter of the frame. Advantageously, the angle formed by the wedge is such that when imaging at shallow angles, the light is not blocked by the wedge-shaped frame section. Due to the larger thickness of the wedge shaped mounting section compared to the thin frame portion, the maximum tensile stress is reduced because the mismatch in overall thickness in the frame is reduced.

Both in FIGS. 2 and 3 a schematic illustration is provided of a light ray A propagating towards detector 15 without obstruction, or with reduced obstruction by the first portion of the frame.

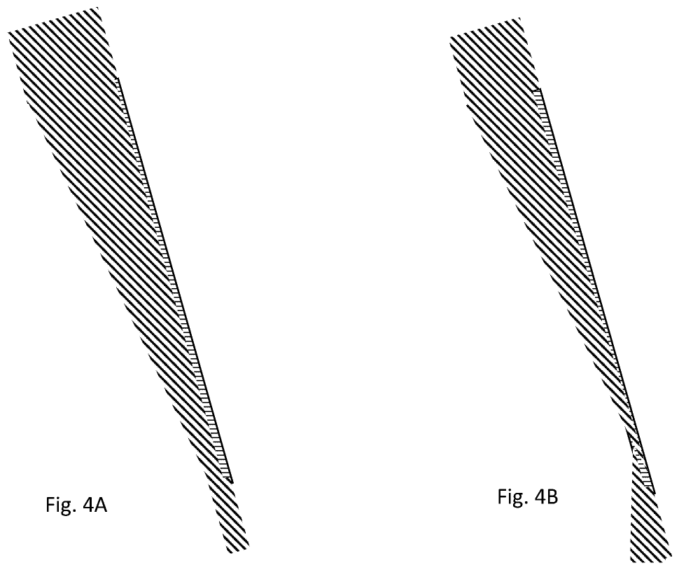

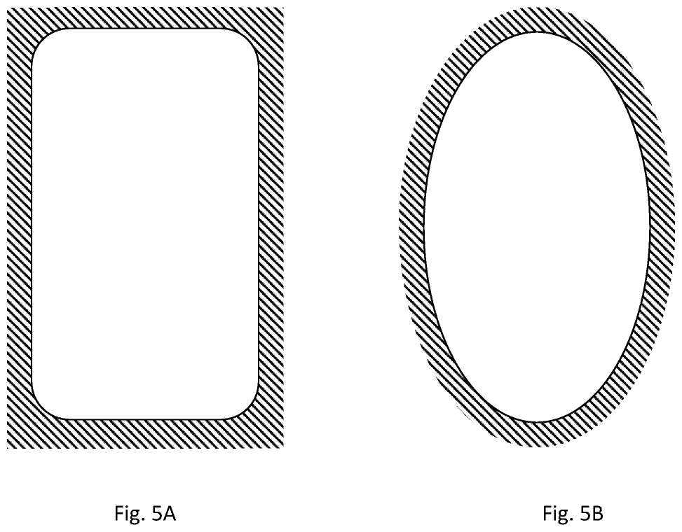

To further reduce the maximum tensile stress in the window, there may be a gradual transition in cross-section between the lower part of the mount and the rest of the mount. A gradual transition avoids a sudden step change of thickness of the mount, and a possible associated discontinuity in expansion. FIG. 4A illustrates a tapered thickness from the wide portion at the top of the mount to the narrow portion at the lower part of the mount. FIG. 4B illustrates a mount which tapers down towards a narrower portion, before widening again slightly, as in the narrow portion of the FIG. 3 example.

Further examples of a window assembly are given in FIG. 5A and FIG. 5B. The external perimeter of the frame is largely rectangular. However, the opening defined by the frame of FIG. 5A whereby the sides are at right angles to each other, but with rounded corners. This further reduces the maximum tensile stress applied to the ceramic window. An alternative embodiment is given in FIG. 5B where both the external perimeter and the opening are oval shaped. It is also contemplated that the external perimeter of the frame may be largely rectangular and the opening may be oval shaped. These outlines in the main plane of the window assembly are all combined with a reduced diameter lower portion of the frame, as discussed previously. A technical effect of these shapes is a more even distribution of stress, and the reduction of tensile stress. However, a drawback of FIGS. 5A and 5B is a reduced field of view, with the FIG. 5B frame having a more restricted field of view than the FIG. 5A frame.

Whether a particular trade-off is acceptable will depend on the particular application, and the skilled person will be able to select the optimal parameters. For example, a high temperature use of the window assembly with a narrow laser beam propagating through the window may require an oval shape as in FIG. 5B, while a lower temperature use of the window for detecting a wide beam of scattered light may require a FIG. 2 frame.

The FIG. 5 front views may be combined with the FIG. 4 side views, to achieve the same technical effect of an improved field of view as for the preceding examples.

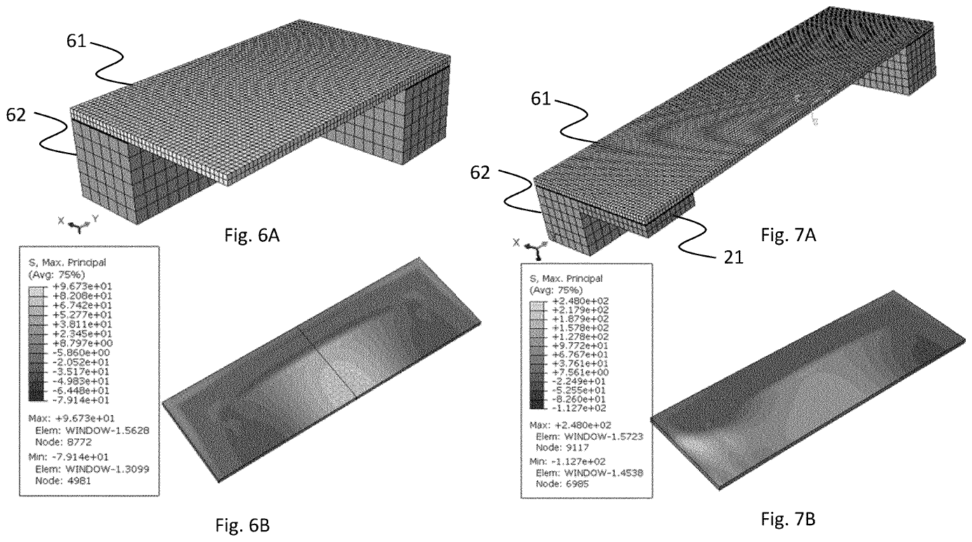

FIG. 6 illustrates stress modelling of a window assembly. The modelling was performed using Abaqus, assuming a polycrystalline diamond window having dimensions of 45 mm×25 mm×600 μm, and a mount made from molybdenum. The diamond to molybdenum bond was modelled as a 100 μm thick high temperature braze, assumed to be perfectly plastic.

FIG. 6A shows a meshed isometric view of a quarter of the window assembly. The quarter of the ceramic window 61 shown is bonded to the mount 62. As can be seen from FIG. 6B, which shows a plot of the modelled principal stress in half of the window, high stresses develop away from the mounted regions of the diamond window, with a modelled maximum tensile stress of 96.73 MPa.

In comparison, FIG. 7 illustrates stress modelling, using the same assumptions as those listed above for FIG. 6, of a window assembly with a decrease of the thickness of a lower portion 21 of the frame, as shown in in FIG. 2, in order to provide an unobstructed optical path. FIG. 7A is a meshed isometric view of a half of the window assembly. As can be seen from FIG. 7B, which shows a plot of the modelled principal stress, the modelled stresses that develop in the ceramic window are higher than those shown in FIG. 6B but still tolerable, with a modelled maximum tensile stress of 248.0 MPa. Unsurprisingly, the stresses are highest around the area bonded to the decreased thickness of a lower portion 21 of the frame.

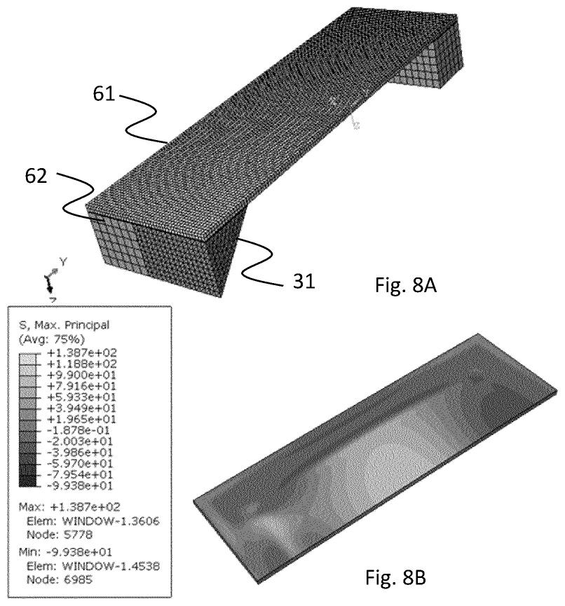

FIG. 8 illustrates stress modelling, using the same assumptions as those listed above for FIG. 6, of a window assembly with a wedge-shaped cross-section 31 part of the frame, as shown in in FIG. 3, in order to provide an unobstructed optical path. A second example of a window assembly is illustrated in FIGS. 3A and 3B. FIG. 8A is a meshed isometric view of a half of the window assembly. As can be seen from FIG. 8B, which shows a plot of the modelled principal stress, the modelled stresses that develop in the ceramic window are higher than those shown in FIG. 6B but still tolerable, with a modelled maximum tensile stress of 138.7 MPa, almost half that of the embodiment shown in FIG. 7. Unsurprisingly, the stresses are highest around the area bonded to the wedge-shaped cross-section 31 part of the frame.

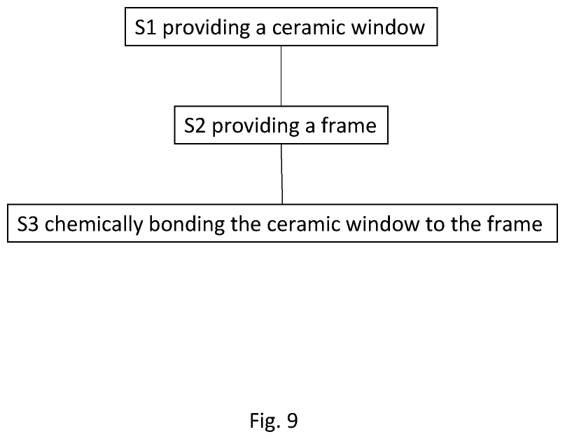

FIG. 9 is a flow diagram of a method of manufacturing a window assembly as described above. The method comprises the steps of: S1 providing the ceramic window; S2 providing the frame; S3 chemically bonding the ceramic window to the frame; wherein the frame comprises two portions, wherein the thickness of a first portion of the two portions in the direction perpendicular to the main plane of the opening is smaller than the thickness of a second of the two portions in the direction perpendicular to the plane of the opening

It will be appreciated that the different improvements presented herein can be used together in various synergistic combinations. For, example, the FIG. 2 example may be used with some, or all of: (1) of a rounding of corners, (2) a modification of the molybdenum alloy for a reduced CTE, (3) a gradual transition between the thick portion and the thin portion. Again, the skilled person will be able to select the optimal parameters for a particular application.

Although the invention has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein.

1. A window assembly comprising:
a frame defining an opening;
a ceramic window;
wherein the frame is bonded to the ceramic window to substantially cover the opening; and
wherein the frame comprises two portions, wherein the thickness of a first portion of the two portions in the direction perpendicular to the main plane of the opening is smaller than the thickness of a second of the two portions in the direction perpendicular to the plane of the opening.

2. The window assembly of claim 1, wherein the first portion is a U-shaped portion, and wherein the second portion bridges the legs of the U-shaped portion.

3. The window assembly of claim 2, wherein the first and second portions together form a rectangular frame.

4. The window assembly of claim 2, wherein the first portion has a cross-section in a direction perpendicular to the main plane of the opening, and wherein the cross-section has a wedge shape, and wherein the narrow part of the wedge shape is on the side of the opening, and wherein the wide part of the wedge shape is on the side of the perimeter of the frame.

5. The window assembly of claim 2, wherein the first portion has a cross-section in a direction perpendicular to the main plane of the opening, and wherein the cross-section is substantially rectangular.

6. The window assembly of claim 1, comprising a gradual transition from the thickness of the first portion to the thickness of the second portion.

7. The window assembly of claim 1, wherein the perimeter of the opening comprises an oval, rectangular shape, or a rectangular shape with rounded corners.

8. The window assembly of claim 1, wherein the external perimeter of the frame comprises an oval, rectangular shape, or a rectangular shape with rounded corners.

9. The window assembly of claim 1, wherein the first portion comprises a coefficient of thermal expansion different from a coefficient of thermal expansion of the second portion.

10. The window assembly of claim 1, wherein the frame comprises molybdenum, and/or wherein the window material is synthetic diamond.

11. The window assembly of claim 1, wherein the material of the first portion comprises a ceramic, synthetic diamond, tungsten, or fused silica material.

12. The window assembly of claim 1, capable of operating at a temperature up to 800° C. without fracturing or without the bond between the window and the frame releasing.

13. The window assembly of claim 1, further comprising a detector, arranged within an optical path defined by the frame and the window, and wherein the optical path is at a non-zero angle to the normal of the main plane.

14. The window assembly of claim 1, wherein the ceramic window has a maximum deflection, measured perpendicular to the plane of the window of no more than 4.5×10⁻⁵ times a longest linear dimension of the window, and preferably no more than 2.0×10⁻⁵ times the longest linear dimension of the window.

15. The ceramic window assembly of claim 1, wherein the ceramic window has a largest linear dimension selected from any of between 10 mm and 130 mm, between 20 mm and 60 mm, and between 25 mm and 50 mm.

16-17. (canceled)

18. The ceramic window assembly of claim 1, wherein the frame is chemically bonded to the ceramic window to substantially cover the opening.

19. A method of manufacturing a window assembly according to claim 1, the method comprising:
providing the ceramic window;
providing the frame
bonding the ceramic window to the frame;
wherein the frame comprises two portions, wherein the thickness of a first portion of the two portions in the direction perpendicular to the main plane of the opening is smaller than the thickness of a second of the two portions in the direction perpendicular to the plane of the opening.

20. The method according to claim 19, further comprising, prior to said step of providing the frame, creating the frame with said first portion comprises a different material from said second portion.

21. The method according to claim 19, further comprising mechanically processing the ceramic window after bonding the ceramic window to the frame.

22. An optical device, comprising a ceramic window assembly according to claim 1.
